(19) United States
(12) Patent Application Publication
(10) Pub. No.: US 2017/0373300 A1
(43) Pub. Date: Dec. 28, 2017

(54) ALL SOLID STATE LITHIUM BATTERY

(71) Applicant: NGK INSULATORS, LTD., Nagoya-Shi (JP)

(72) Inventors: Kazuki MAEDA, Nagoya-Shi (JP); Toshihiro YOSHIDA, Nagoya-Shi (JP); Masahiro SHIMONO, Nagoya-Shi (JP); Natsumi SHIMOGAWA, Nagoya-Shi (JP)

(73) Assignee: NGK INSULATORS, LTD., Nagoya-Shi (JP)

(21) Appl. No.: 15/696,571

(22) Filed: Sep. 6, 2017

Related U.S. Application Data
(63) Continuation of application No. PCT/JP2016/057652, filed on Mar. 10, 2016.

(30) Foreign Application Priority Data
Mar. 25, 2015 (JP) 2015-062652

(51) Int. Cl. H01M 2/34; H01M 10/0525; H01M 4/525; H01M 2/08; H01M 2/02; H01M 2/30; H01M 2/16; H01M 2/14; H01M 4/131; H01M 4/505

(52) U.S. Cl. CPC H01M 2/34; H01M 4/131; H01M 10/0525; H01M 4/525; H01M 4/505; H01M 2/0202; H01M 2/30; H01M 2/1653; H01M 2/145; H01M 2/08; H01M 2220/30

(57) ABSTRACT

Provided is an all-solid-state lithium battery including an oriented positive electrode plate composed of an oriented polycrystalline body made of lithium transition metal oxide grains, a solid electrolyte layer, a negative electrode layer, and an end insulator insulating and coating ends of the oriented positive electrode plate. The surface of the end insulator and the surface of the oriented positive electrode plate adjacent the solid electrolyte layer form one continuous surface no step exists. Alternatively, the height of the surface of the end insulator adjacent the solid electrolyte layer is lower than that of the surface of the oriented positive electrode plate adjacent the solid electrolyte layer to form a discontinuous surface with proviso that a step between the end insulator and the surface of the oriented positive electrode plate adjacent the solid electrolyte layer is smaller than the thickness of the solid electrolyte layer.

### CROSS-REFERENCE TO RELATED APPLICATIONS

This application is a continuation application of PCT/JP2016/057652 filed Mar. 10, 2016, which claims priority to Japanese Patent Application No. 2015-062652 filed Mar. 25, 2015, the entire contents all of which are incorporated herein by reference.

### BACKGROUND OF THE INVENTION

### 1. Field of the Invention

The present invention relates to all-solid-state lithium batteries.

### 2. Description of the Related Art

The recent development of portable devices, such as personal computers and cellular phones, has been greatly expanding the demand for batteries as the power sources of the devices. Traditional batteries for such application contain liquid electrolytes (electrolytic solutions) containing flammable organic diluent solvents, as media for ion transfer. The battery containing such an electrolytic solution has a risk of the leakage of the electrolytic solution, ignition, explosion, or the like.

To solve the problems, an all-solid-state lithium battery has been developed that contains a solid electrolyte instead of a liquid electrolyte and consists of only solid components for ensuring the intrinsic safety. The all-solid-state lithium battery, which contains a solid electrolyte, has a low risk of ignition, causes no liquid leakage, and barely causes a decline in the battery performance due to corrosion.

For example, Patent Document 1 (JP2013-105708A) discloses a thin-film lithium secondary battery including a positive electrode layer made of lithium cobaltate (LiCoO₂), a negative electrode layer made of metallic lithium, and a solid electrolyte layer that can be formed of a lithium phosphate oxynitride (LiPON) glass electrolyte, and describes that the positive electrode layer is formed by sputtering and has a thickness within a range of 1 to 15 μm. An all-solid-state lithium battery having an improved capacity by increasing the thickness of the positive electrode has also been proposed. For example, Patent Document 2 (JP2009-516359A) each disclose an all-solid-state lithium battery including a positive electrode having a thickness of more than approximately 4 μm and less than approximately 200 μm, a solid electrolyte having a thickness of less than approximately 10 μm, and a negative electrode having a thickness of less than approximately 30 μm. These documents do not describe the orientation of positive electrode active materials at all.

An oriented sintered plate made of lithium complex oxide has been proposed. For example, Patent Document 3 (JP2012-009193A) and Patent Document 4 (JP2012-009194A) each disclose a lithium-complex-oxide sintered plate having a layered rock-salt structure and having a diffraction intensity ratio [003]/[104] of 2 or less of the (003) plane to of the (104) plane in X-ray diffraction. Patent Document 5 (JP4745463B) discloses platy particles that are expressed by the general formula: Liₚ(Niₓ,Co_{y},Al_{z})O₂ (where 0.9≦p≦1.3, 0.6<x≦0.9, 0.1<y≦0.3, 0≦z≦0.2, and x+y+z=1), that have a layered rock-salt structure, and in which the (003) plane is oriented so as to intersect the plate surface of the particle.

A garnet-type ceramic material having a composition Li—La—Zr—O-based complex oxide (LLZ) represented by Li₇La₃Zr₂O₁₂ has received attention as a solid electrolyte having lithium-ion conductivity. For example, according to Patent Document 6 (JP2011-051800A), addition of Al to Li, La, and Zr, which are the basic elements of LLZ, improves denseness and lithium-ion conductivity. According to Patent Document 7 (JP2011-073962A), addition of Nb and/or Ta to Li, La, and Zr, which are the basic elements of LLZ, further improves lithium-ion conductivity. Patent Document 8 (JP2011-073963A) discloses that a composition containing Li, La, Zr, and Al in a molar ratio of Li to La of 2.0 to 2.5 further improves denseness.

In thin-film lithium ion batteries, the negative electrode expands during a charging operation in some cases, and techniques dealing with such expansion are known. For example, in Patent Document 9 (JP2010-519675A), the whole of the solid electrolyte layer and the anode layer of a laminated battery are coated with a sealing material (barrier material) including a polymer-seal layer, a metal foil layer, and a polymer outer layer in this order for preventing infiltration of oxygen and water vapor from the outside, while absorbing the expansion of the anode during a charging operation.

### CITATION LIST

### Patent Documents

Patent Document 1: JP2013-105708A
Patent Document 2: JP2009-516359A
Patent Document 3: JP2012-009193A
Patent Document 4: JP2012-009194A
Patent Document 5: JP4745463B
Patent Document 6: JP2011-051800A
Patent Document 7: JP2011-073962A
Patent Document 8: JP2011-073963A
Patent Document 9: JP2010-519675A

### SUMMARY OF THE INVENTION

The all-solid-state lithium battery as shown in Patent Document 9 is referred to as a thin-film battery. In the thin-film battery, the positive electrode layer is generally formed by sputtering. Unfortunately, the sputtering cannot form a positive electrode layer (which has a role as a reservoir of lithium ions) having a large thickness, hence, the battery disadvantageously has a small capacity and a low energy density. This is because that the positive electrode layer formed by sputtering has low lithium conductivity and that a thick positive electrode precludes efficient intercalation and deintercalation of lithium ions over the entire thickness of the positive electrode layer. For example, lithium present apart from the solid electrolyte of the thick positive electrode layer cannot be sufficiently deintercalated. In contrast, as schematically shown in FIG. 5, a positive electrode layer 112 formed by sputtering has a thickness continuously decreasing toward the end, hence, the boundary between the substrate 120 and the positive electrode layer 112 is continuous. Consequently, the mere formation of a solid electrolyte 114, such as LiPON, and a negative electrode layer 116 in series on a positive electrode layer 112 can certainly separate the positive electrode layer 112 and the negative electrode layer 116 from each other with the solid electrolyte layer 114 therebetween by without requiring specific measures. As a result, insulation between the positive and negative electrodes is secured to prevent short-circuiting.

In contrast, the inventors have worked for developing an all-solid-state lithium battery including an oriented positive electrode plate. This oriented positive electrode plate is composed of an oriented polycrystalline body made of lithium transition metal oxide grains oriented in a predetermined direction. Even if a thick positive electrode active material is disposed, efficient intercalation and deintercalation of lithium ions can be readily performed over the entire thickness of the positive electrode layer, resulting in a maximum effect of increasing the capacity due to a thick positive electrode active material. For example, lithium present in the thick positive electrode layer apart from the solid electrolyte can be sufficiently used for charge and discharge. Such an increase in capacity can also highly increase the energy density of the all-solid-state lithium battery. That is, such an all-solid-state lithium battery can have battery performance showing a large capacity and a high energy density. Accordingly, the all-solid-state lithium battery can have high safety, large capacity, and a high energy density in spite of its relatively thin or small size. In particular, the oriented positive electrode plate can be composed of a ceramic sintered body and, thus, can be readily formed into a large thickness, compared to a film formed by a gas phase process, such as sputtering, and can advantageously have a precisely controlled composition by strictly weighing the raw material powders. That is, the all-solid-state lithium battery including an oriented positive electrode plate has an advantage in that the capacity and energy density of a battery can be increased by increasing the thickness of the positive electrode.

In addition, since the oriented positive electrode plate is produced in a sheet shape, unlike the positive electrode layer 112 formed by sputtering as shown in FIG. 5, the thickness of the oriented positive electrode plate 42 is steeply decreased at the end as shown in FIG. 4, and the boundary between the substrate 50 and the oriented positive electrode plate 42 is not continuous. In particular, as shown in FIG. 4, the oriented positive electrode plate 42 disposed on the substrate 50 with an adhesive 58 therebetween further enlarges the step between the substrate 50 and the oriented positive electrode plate 42. Accordingly, if a solid electrolyte layer 44, such as LiPON, and a negative electrode layer 46 are merely formed on an oriented positive electrode plate 42, the solid electrolyte layer 44 and the negative electrode layer 46 are also formed at the innermost portion of the gap near the end of the oriented positive electrode plate 42, as shown in FIG. 4. In such a case, the negative electrode layer 46 may adhere to the side surface at the end of the oriented positive electrode plate 42, leading to a risk of insufficient insulation at the end of the oriented positive electrode plate 42. In the vicinity of the corner of the oriented positive electrode plate 42 on the solid electrolyte layer 44, defects of the solid elecctrolyte layer 44 are relatively easy to occur, compared to other portions, due to a local decrease in the film-forming ability. It is conceivable that desirable insulation can be achieved by avoiding such a local decrease in the film forming ability by forming the solid electrolyte layer 44 so as to have a large thickness for sufficiently coating the side surface at the end of the oriented positive electrode plate 42. However, such a large thickness of the solid electrolyte layer may be undesirable in view of charge-discharge rate. Accordingly, an insulation structure that can secure isolation with a relatively thin solid electrolyte layer 44 (e.g., 3 μm) is desired. The oriented positive electrode plate has characteristics of expanding in the surface direction by deintercalation of lithium ions during a charging operation, leading to a risk of cracking of the oriented positive electrode plate and peeling at the interface between the oriented positive electrode plate and the solid electrolyte layer. Such cracking and peeling deteriorate the performance. Accordingly, it is desirable to relieve the stress due to the expansion.

The present inventors have found that short-circuiting between an oriented positive electrode plate and a negative electrode layer in an all-solid-state lithium battery can be effectively prevented while relieving the stress due to expansion of the oriented positive electrode plate during a charging operation by disposing an end insulator insulating and coating the end of the oriented positive electrode plate such that no step exists between the end insulator and the surface of the oriented positive electrode plate adjacent the solid electrolyte layer or such that even if a step exists between the end insulator and the surface of the oriented positive electrode plate adjacent the solid electrolyte layer, the step is smaller than the thickness of the solid electrolyte layer.

Accordingly, it is an object of the present invention to provide an all-solid-state lithium battery including an oriented positive electrode plate and capable of effectively preventing short-circuiting between the oriented positive electrode plate and a negative electrode layer while relieving the stress due to expansion of the oriented positive electrode plate during a charging operation.

An embodiment of the present invention provides an all-solid-state lithium battery comprising:
an oriented positive electrode plate composed of an oriented polycrystalline body made of oriented lithium transition metal oxide grains;
a solid electrolyte layer composed of a lithium-ion conductive material disposed on the oriented positive electrode plate;
a negative electrode layer disposed on the solid electrolyte layer; and an end insulator insulating and coating ends of the oriented positive electrode plate, wherein the surface of the end insulator adjacent the solid electrolyte layer and the surface of the oriented positive electrode plate adjacent the solid electrolyte layer form one continuous surface such that no step exists between the end insulator and the surface of the oriented positive electrode plate adjacent the solid electrolyte layer; or the height of the surface of the end insulator adjacent the solid electrolyte layer is lower than that of the surface of the oriented positive electrode plate adjacent the solid electrolyte layer to form a discontinuous surface with proviso that the difference in level of a step between the end insulator and the surface of the oriented positive electrode plate adjacent the solid electrolyte layer is smaller than the thickness of the solid electrolyte layer.

### BRIEF DESCRIPTION OF THE DRAWINGS

FIG. 1 is a schematic cross-sectional view illustrating an example of the all-solid-state lithium battery of the present invention.

FIG. 2 is a schematic top view of the all-solid-state lithium battery shown in FIG. 1.

FIG. 3 is a schematic cross-sectional view illustrating the end structure of the all-solid-state lithium battery shown in FIG. 1.

FIG. 4 is a schematic cross-sectional view illustrating the end structure of the all-solid-state lithium battery produced so as to include an oriented positive electrode plate but not including any end insulator.

FIG. 5 is a schematic cross-sectional view illustrating the end structure of a thin-film battery according to a known technique.

### DETAILED DESCRIPTION OF THE INVENTION

### All-Solid-State Lithium Battery

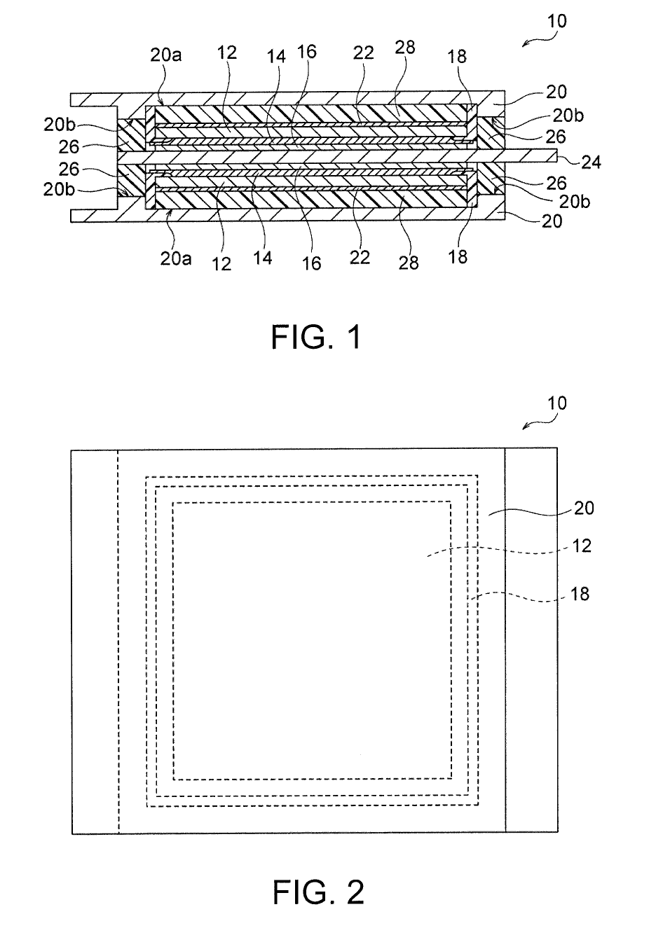

FIGS. 1 and 2 schematically show an example of the all-solid-state lithium battery according to the present invention. The all-solid-state lithium battery 10 shown in FIGS. 1 and 2 includes oriented positive electrode plates 12, solid electrolyte layers 14, negative electrode layers 16, and end insulators 18. The all-solid-state lithium battery 10 shown in FIG. 1 has a structure where two unit cells each including an oriented positive electrode plate 12, a solid electrolyte layer 14, a negative electrode layer 16, and an end insulator 18 are stacked with vertical symmetry with respect to a negative electrode cladding 24 therebetween. The all-solid-state lithium battery may include a single unit cell or may include two or more unit cells connected in parallel or in series. The oriented positive electrode plate 12 includes an oriented polycrystalline body made of oriented lithium transition metal oxide grains. The solid electrolyte layer 14 is disposed on the oriented positive electrode plate 12 and includes a lithium-ion conductive material. The negative electrode layer 16 is disposed on the solid electrolyte layer 14. The end insulator 18 is disposed so as to insulate and coat the ends of the oriented positive electrode plate 12. Specifically, the end insulator 18 is disposed such that the surface of the end insulator 18 adjacent the solid electrolyte layer 14 and the surface of the oriented positive electrode plate 12 adjacent the solid electrolyte layer 14 form one continuous surface such that no step exists between the end insulator 18 and the surface of the oriented positive electrode plate 12 adjacent the solid electrolyte layer 14. This one surface has a continuous surface profile and may be a flat surface, a curved surface, or a surface having a flat part and a curved part. Alternatively, the end insulator 18 may be disposed such that the height of the surface of the end insulator 18 adjacent the solid electrolyte layer 14 is lower than that of the surface of the oriented positive electrode plate 12 adjacent the solid electrolyte layer 14 to form a discontinuous surface such that the difference in level of a step between the end insulator 18 and the surface of the oriented positive electrode plate 12 adjacent the solid electrolyte layer 14 is smaller than the thickness of the solid electrolyte layer 14. The all-solid-state lithium battery having any of the above structures is free from short-circuiting between the oriented positive electrode plate 12 and the negative electrode layer 16, while relieving the expansion stress of the oriented positive electrode plate 12 during a charging operation.

This technical phenomemon can be explained as follows. If the surface of the end insulator 18 adjacent the solid electrolyte layer 14 and the surface of the oriented positive electrode plate 12 adjacent the solid electrolyte layer 14 form one continuous surface without a step between the end insulator 18 and the surface of the oriented positive electrode plate 12 adjacent the solid electrolyte layer 14. In such a case, as shown in FIG. 1, the height of the surface of the end insulator 18 adjacent the solid electrolyte layer 14 is equal to or higher than that of the oriented positive electrode plate 12. Thus, the side surface at the end of the oriented positive electrode plate 12 is entirely coated with the end insulator 18, and the negative electrode layer 16 no longer contacts the side face. As a result, short-circuiting at the end side can be prevented. In addition, the end insulator 18 and the surface of the oriented positive electrode plate 12 adjacent the solid electrolyte layer 14 form one continuous surface, hence the corner of the oriented positive electrode plate 12 adjacent the solid electrolyte layer 14 is not exposed. In this state, the solid electrolyte layer 14 is continuously formed (i.e., smoothly formed along one continuous surface), hence, film defects are prevented from occurring in the solid electrolyte layer 14 at the end of the oriented positive electrode plate 12. That is, as described above, although defects of the solid electrolyte layer 14 relatively readily occur in the vicinity of the corner, compared to other portions, due to a decrease in the film-forming ability, the defects of the solid electrolyte layer 14, which may be caused by such a corner of the oriented positive electrode plate 12, are eliminated by not exposing the corner, leading to prevention of short-circuiting above the end of the oriented positive electrode plate 12. In addition, the oriented positive electrode plate 12 expands in the surface direction by deintercalation of lithium ions during a charging operation, but the end insulator 18 suppresses or absorbs the expansion of the oriented positive electrode plate 12 during a charging operation to relieve the stress. Accordingly, cracking of the oriented positive electrode plate 12, peeling at the interface between the oriented positive electrode plate 12 and the solid electrolyte layer 14, and deterioration in the performance caused thereby can be decreased.

In the case where the height of the surface of the end insulator 18 adjacent the solid electrolyte layer 14 is lower than that of the surface of the oriented positive electrode plate 12 adjacent the solid electrolyte layer 14 to form a discontinuous surface, a step is formed between the end insulator 18 and the surface of the oriented positive electrode plate 12 adjacent the solid electrolyte layer 14. Even in such a case, if the end insulator 18 is disposed such that the difference in level of the step is smaller than the thickness of the solid electrolyte layer 14, the same or similar effect can be expected. This is because that even if a small difference in level of the step is present as described above, the above-mentioned defect can be cancelled out by the solid electrolyte layer 14 having a thickness larger than the difference. That is, although the height of the surface of the end insulator 18 adjacent the solid electrolyte layer 14 is lower than that of the oriented positive electrode plate 12, the side surface at the end of the oriented positive electrode plate 12 is entirely coated with the end insulator 18 and the solid electrolyte layer 14 formed on the end insulator 18, and the negative electrode layer 16 no longer contacts the side face. As a result, short-circuiting at the end side can be prevented. The height of the surface of the end insulator 18 is lower than that of the surface of the oriented positive electrode plate 12 adjacent the solid electrolyte layer 14 to form a discontinuous surface, but the corner of the oriented positive electrode plate 12 adjacent the solid electrolyte layer 14 is buried in the solid electrolyte layer 14 having a thickness larger than the difference in level of the step. As a result, the defects of the solid electrolyte layer 14, which may be caused by the corner of the oriented positive electrode plate 12, are eliminated, and short-circuiting above the end of the oriented positive electrode plate 12 can be prevented. In addition, as described above, the end insulator 18 suppresses or absorbs the expansion of the oriented positive electrode plate 12 during a charging operation to relieve the stress. Accordingly, cracking of the oriented positive electrode plate 12, peeling at the interface between the oriented positive electrode plate 12 and the solid electrolyte layer 14, and deterioration in the performance caused thereby can be decreased. Thus, although a difference in level of the step between the end insulator 18 and the surface of the oriented positive electrode plate 12 adjacent the solid electrolyte layer 14 is acceptable, a smaller difference is preferred. Such a difference in level of the step is 100% or less of the thickness of the solid electrolyte layer 14, preferably 80% or less, more preferably 60% or less, more preferably 40% or less, more preferably 20% or less, and most preferably 10% or less.

### Oriented Positive-electrode Plate

The oriented positive electrode plate 12 is composed of an oriented polycrystalline body made of orieted lithium transition metal oxide grains. That is, the grains constituting the oriented positive electrode plate 12 or oriented polycrystalline body are composed of lithium transition metal oxide. The lithium transition metal oxide preferably has a layered rock-salt structure or a spinel structure, more preferably a layered rock-salt structure. The layered rock-salt structure has such characteristics that the occlusion of lithium ions decreases the oxidation-reduction potential and the exclusion of lithium ions increases the oxidation-reduction potential. The layered rock-salt structure is a crystal structure including layers of transition metal other than lithium and lithium layers that are alternately stacked with oxygen-atom layers disposed therebetween, i.e., a crystal structure including layers of transition metal ions other than lithium and lithium-ion layers that are alternately stacked with oxide ions disposed therebetween (typically an α-NaFeO₂-type structure of transition metal and lithium regularly arrayed in the [111] axis direction of a cubic rock-salt structure). Typical examples of lithium-transition metal complex oxide having a layered rock-salt structure include lithium nickelate, lithium manganate, lithium nickel manganate, lithium nickel cobaltate, lithium cobalt nickel manganate, and lithium cobalt manganate, and these materials may further contain one or more other elements, such as Mg, Al, Si, Ca, Ti, V, Cr, Fe, Cu, Zn, Ga, Ge, Sr, Y, Zr, Nb, Mo, Ag, Sn, Sb, Te, Ba, and Bi.

In specific, the lithium transition metal oxide grains preferably have a composition represented by LiₓM1O₂ or Liₓ(M1,M2)O₂ where 0.5<x<1.10, M1 is at least one transition metal element selected from the group consisting of Ni, Mn, and Co, and M2 is at least one element selected from the group consisting of Mg, Al, Si, Ca, Ti, V, Cr, Fe, Cu, Zn, Ga, Ge, Sr, Y, Zr, Nb, Mo, Ag, Sn, Sb, Te, Ba, and Bi; more preferably a composition represented by Liₓ(M1,M2)O₂ where M1 is Ni and Co and M2 is at least one element selected from the group consisting of Mg, Al, and Zr; and most preferably a composition represented by Liₓ(M1,M2)O₂ where M1 is Ni and Co and M2 is Al. Preferably, the atomic ratio of Ni to the total amount of M1 and M2 is 0.6 or more. These compositions can have layered rock-salt structures. Ceramics having a Liₓ(Ni,Co,Al)O₂-based composition, where M1 are Ni and Co and M2 is Al, are called NCA ceramics in some cases. A particularly preferred NCA ceramic is represented by the general formula: Liₚ(Niₓ,Co_{y},Al_{z})O₂ (where 0.9≦p≦1.3, 0.6<x≦0.9, 0.1<y≦0.3, 0≦z≦0.2, and x+y+z=1) and has a layered rock-salt structure. Also preferred are lithium transition metal oxides having a composition represented by LiₓM1O₂ where M1 is Ni, Mn, and Co or M1 is Co.

As described above, the oriented positive-electrode plate 12 comprises an oriented polycrystalline body composed of lithium transition metal oxide grains oriented in a predetermined direction. This predetermined direction is preferably the direction of lithium ion conduction. Typically, the specific crystal face of each grain constituting the oriented positive electrode plate 12 is oriented in the direction from the oriented positive electrode plate 12 toward the negative electrode layer 16. Preferably, the lithium transition metal oxide grains have a platy shape with a thickness of approximately 2 to 100 μm. More preferably, the specific crystal face is the (003) plane oriented in the direction from the oriented positive-electrode plate 12 toward the negative electrode layer 16. This can discharge a large number of lithium ions at the time of high input (charge) and can receive a large number of lithium ions at the time of high output (discharge) without preventing intercalation or deintercalation of lithium ions into or from the oriented positive-electrode plate 12. Planes other than the (003) plane, for example, the (101) and (104) planes may be oriented along the plate surface of the oriented positive-electrode plate 12. The details of the grains and oriented polycrystalline body are described in Patent Documents 3 to 5, the contents of which are incorporated herein by reference.

The oriented polycrystalline body has a degree of orientation of 10% or more, preferably 15% to 95%, for example, 15% to 85%. More specifically, the lower limit of the degree of orientation is 10% or more, preferably 20% or more, more preferably 30% or more, more preferably 40% or more, and most preferably 50% or more. The upper limit of the degree of orientation should not be defined, but may be, for example, 95% or less, 90% or less, 85% or less, 80% or less, 75% or less, or 70% or less. The degree of orientation may be determined at the surface of the oriented positive electrode plate 12 as the sample surface, through the X-ray diffraction analysis at 2°/min and a step width of 0.02° in a 2θ range of 10° to 70° with an XRD apparatus (e.g., manufactured by Rigaku Corporation, TTR-III) and calculation of the degree of orientation from the resulting XRD profile by a Lotgering method based on the following expression:

$$\begin{matrix}[ Math 1 ] & \\ Degree of orientation F = \frac{\frac{Σ I ( HKL )}{Σ I ( hkl )} - \frac{Σ {I}_{0} ( HKL )}{Σ {I}_{0} ( hkl )}}{1 - \frac{Σ {I}_{0} ( HKL )}{Σ {I}_{0} ( hkl )}} 100 & ( 1 )\end{matrix}$$

where, I represents the diffraction intensity of the oriented positive electrode plate sample; I₀ represents the diffraction intensity of a non-oriented reference sample; (HKL) represents the diffraction lines for evaluating the degree of orientation and corresponds to diffraction lines other than (001) (I is, for example, 3, 6, and 9); and (hkl) corresponds to all diffraction lines.

The non-oriented reference sample has the same structure as that of the oriented positive electrode plate sample except for not being oriented and can be prepared by, for example, pulverizing an oriented positive electrode plate sample in a mortar into a non-oriented state. In the expression mentioned above, the diffraction line of (001) is not included in (HKL) because lithium ions cannot move in directions other than the in-plane direction (direction parallel to the plane) in the plane corresponding to this diffraction line (e.g., (003) plane). If the plane is oriented along the surface of the oriented positive electrode plate 12, lithium ions are prevented from moving. Accordingly, it is preferred that lithium transition metal oxide grains are oriented such that the specific crystal faces of the grains are oriented in a direction crossing the plate surface of the oriented positive electrode plate. In particular, it is preferred that the lithium transition metal oxide grains have a layered rock-salt structure and that the specific crystal face is the (003) plane. That is, the (003) plane of the layered rock-salt structure is preferably oriented in a direction crossing the plate surface of the oriented positive electrode plate 12. Namely, the direction crossing the plate surface of the oriented positive electrode plate 12 is the direction of lithium ion conduction. According to this structure, the (003) plane of each grain constituting the oriented positive electrode plate 12 is oriented in the direction from the oriented positive electrode plate 12 toward the negative electrode layer 16.

As described above, the oriented polycrystalline body of the oriented positive-electrode plate 12 can be readily thickened compared to non-oriented polycrystalline bodies. In order to increase the amount of the active material per unit area, the oriented polycrystalline body preferably has a thickness of at least 10 μm, more preferably at least 13 μm, further preferably at least 16 μm, particularly preferably at least 20 μm, and most preferably at least 25 μm. Although the thickness has no upper limit, the upper limit is preferably less than 100 μm, more preferably 90 μm or less, more preferably 80 μm or less, more preferably 70 μm or less, and most preferably 60 μm, from the viewpoint of suppressing degradation of battery characteristics (in particular, an increase in resistance) due to repeated charge and discharge cycles. The thickness of the oriented positive electrode plate 12 is preferably 10 μm or more, more preferably 10 to 100 μm, more preferably 15 to 80 μm, more preferably 20 to 70 μm, and most preferably 20 to 60 μm.

Preferably, the oriented positive-electrode plate 12 has a sheet shape. A preferred method of preparing the sheet positive-electrode active material (hereinafter referred to as a positive-electrode active material sheet) will be described later. The oriented positive-electrode plate 12 may be composed of a single positive-electrode active material sheet or a laminate of several sheets prepared by division of a positive-electrode active material sheet.

The oriented polycrystalline body constituting the oriented positive electrode plate 12 preferably has a relative density of 75% to 99.97%, more preferably 80% to 99.95%, more preferably 90% to 99.90%, more preferably 95% to 99.88%, and most preferably 97% to 99.85%. A higher relative density is basically preferred from the viewpoint of capacity and energy density, but in order to prevent an increase in the resistance due to repeated charge and discharge cycles, a relative density within the above-mentioned range is preferred. It is believed that the oriented positive electrode plate 12 having a relative density within the above-mentioned range can be appropriately expanded and contracted by the deintercalation and intercalation of lithium, resulting in relief of the expansion stress.

### Solid Electrolyte Layer

The lithium-ion conductive material of the solid electrolyte layer 14 is preferably a garnet-based ceramic material, a nitride-based ceramic material, a perovskite-based ceramic material, a phosphate-based ceramic material, a sulfide-based ceramic material, or a polymer-based material, and more preferably at least one selected from the group consisting of a garnet-based ceramic material, a nitride-based ceramic material, a perovskite-based ceramic material, and a phosphate-based ceramic material. Examples of the garnet-based ceramic material include a Li—La—Zr—O-based material (in specific, Li₇La₃Zr₂O₁₂), a Li—La—Ta—O-based material (in specific, Li₇La₃Ta₂O₁₂). Examples of the nitride-based ceramic material include Li₃N. Examples of the perovskite-based ceramic material include Li—La—Zr—O-based materials (in specific, LiLa₁₋ₓTiₓO₃ (0.04≦x≦0.14)). Examples of the phosphate-based ceramic material include lithium phosphate, nitrogen-doped lithium phosphate (LiPON), Li—Al—Ti—P—O, Li—Al—Ge—P—O, and Li—Al—Ti—Si—P—O (in specific, Li_{1+x+y}AlₓTi₂₋ₓSi_{y}P_{3-y}O₁₂ (0≦x≦0.4 and 0<y≦0.6)).

The lithium-ion conductive material of the solid electrolyte layer 14 is preferably composed of a Li—La—Zr—O ceramic material and/or a lithium phosphate oxynitride (LiPON) ceramic material. The Li—La—Zr—O material is a sintered oxide having a garnet or pseudo-garnet crystal structure containing Li, La, Zr, and O, specifically, a garnet ceramic material, such as Li₇La₃Zr₂O₁₂. Examples of such a material include those described in Patent Documents 6 to 8, and the contents of these documents are incorporated into the specification by reference. The garnet-based ceramic material is a lithium-ion conductive material which does not react with lithium in the negative electrode even after direct contact. In particular, a sintered oxide having a garnet-type or pseudo-garnet-type crystal structure containing Li, La, Zr, and O has excellent sintering properties, is readily densified, and has high ion conductivity. The garnet-type or pseudo-garnet-type crystal structure having such a composition is called an LLZ crystal structure and has an XRD pattern similar to that in X-ray diffraction file No. 422259(Li₇La₃Zr₂O₁₂) in Cambridge Structural Database (CSD). The structure may have constituent elements different from that in No. 422259 and may have a Li content in the ceramic different from that in No. 422259, and thus may have a diffraction angle and diffraction intensity profile different from that in No. 422259. Preferably, the molar ratio Li/La of Li to La is 2.0 or more and 2.5 or less, and the molar ratio Zr/La of Zr to La is 0.5 or more and 0.67 or less. The garnet-type or pseudo-garnet-type crystal structure may further contain Nb and/or Ta. That is, partial replacement of Zr in LLZ with Nb and/or Ta improves conductivity in comparison to before the replacement.

Preferably, Zr is replaced with Nb and/or Ta such that the molar ratio (Nb+Ta)/La is 0.03 or more and 0.20 or less. It is preferred that the garnet-based sintered oxide further contain Al, and these elements may be present in the crystal lattice or at positions other than the crystal lattice. Preferably, Al is added in an amount of 0.01 to 1 mass % of the sintered oxide, and the molar ratio Al/La of Al to La is 0.008 to 0.12. Such an LLZ-based ceramic is prepared according to or by appropriately modifying a known process described in Patent Documents 6 to 8, the contents of which are incorporated herein by reference. Lithium phosphate oxynitride (LiPON) ceramic materials are also preferred. LiPON is a compound group represented by the composition of Li_{2.9}PO_{3.3}N_{0.46} and is a compound group denoted by, for example, LiₐPO_{b}N_{c} (where, a is 2 to 4; b is 3 to 5; and c is 0.1 to 0.9).

The solid electrolyte layer 14 may have any size; and its thickness is preferably 0.0005 to 0.5 mm, more preferably 0.001 to 0.1 mm, and most preferably 0.002 to 0.05 mm, in view of charge-discharge rate characteristics and mechanical strength.

The solid electrolyte layer 14 may be formed by a particle jet coating process, a solid phase process, a solution process, or a gas phase process. Examples of the particle jet coating process include aerosol deposition (AD), gas deposition (GD), powder jet deposition (PJD), cold spraying (CS), and flame coating. The aerosol deposition (AD) is particularly preferred because it can be carried out at room temperature, thus preventing a variation in a composition during the process and formation of a high-resistance layer due to reaction with an oriented positive-electrode plate. Examples of the solid phase process include tape lamination processes and printing processes. Tape lamination processes are preferred because they can form a thin solid electrolyte layer 14 and facilitate the thickness control. Examples of the solution process include solvothermal synthesis, hydrothermal synthesis, sol-gel processes, precipitation processes, microemulsion processes, and solvent evaporation processes. Hydrothermal synthesis is particularly preferred among these processes because it can readily yield highly crystalline crystal grains at low temperature. Microcrystals synthesized by these processes may be deposited or directly precipitated on the positive electrode. Examples of the gas phase process include laser deposition (PLD), sputtering, evaporation-condensation (PVD), chemical vapor deposition (CVD), vacuum deposition, and molecular beam epitaxy (MBE). The laser deposition (PLD) is particularly preferred because it causes a small variation in a composition and readily yields a relatively high-crystalline film.

The interface between the oriented positive electrode plate 12 and the solid electrolyte layer 14 may be treated for reducing the interface resistance. For example, the surface of the oriented positive electrode plate 12 and/or the solid electrolyte layer 14 can be coated with niobium oxide, titanium oxide, tungsten oxide, tantalum oxide, lithium-nickel composite oxide, lithium-titanium composite oxide, a lithium-niobium compound, a lithium-tantalum compound, a lithium-tungsten compound, a lithium-titanium compound, or any combination or composite oxide thereof. Although such treatment forms a coat at the interface between the oriented positive electrode plate 12 and the solid electrolyte layer 14, the thickness of the coat is significantly small, such as 20 nm or less.

### Negative Electrode Layer

The negative electrode layer 16 contains a negative-electrode active material, and the negative-electrode active material may be known negative-electrode active materials that can be used in all-solid-state lithium batteries. Preferred examples of the negative-electrode active material include lithium metal, lithium alloy, carbonaceous materials, and lithium titanate (LTO). Preferably, the negative electrode layer 16 is prepared by placing a negative-electrode active material in a foil form (for example, lithium metal foil) on the solid electrolyte layer 14 or a negative-electrode collector 15 or, in the alternative, by forming a thin film of lithium metal or an alloy of lithium metal and any other metal on the solid electrolyte layer 14 or a negative-electrode collector 15 by vacuum deposition, sputtering, CVD, or the like.

It is preferred to dispose an intermediate layer between the negative electrode layer 16 and the solid electrolyte layer 14. The intermediate layer can be composed of a metal alloyable with lithium or an oxide material. Such a case can improve the charge and discharge cycle characteristics. Examples of the metal alloyable with lithium include aluminum (Al), silicon (Si), zinc (Zn), gallium (Ga), germanium (Ge), silver (Ag), gold (Au), cadmium (Cd), indium (In), tin (Sn), antimony (Sb), lead (Pb), bismuth (Bi), and combinations thereof. The metal alloyable with lithium may be an alloy composed of two or more elements, such as Mg₂Si and Mg₂Sn. Examples of the oxide material include Li₄Ti₅O₁₂ and TiO₂, SiO. The intermediate layer may be formed by a known method, such as an aerosol deposition (AD) method, a pulse laser deposition (PLD) method, or sputtering.

### End insulator

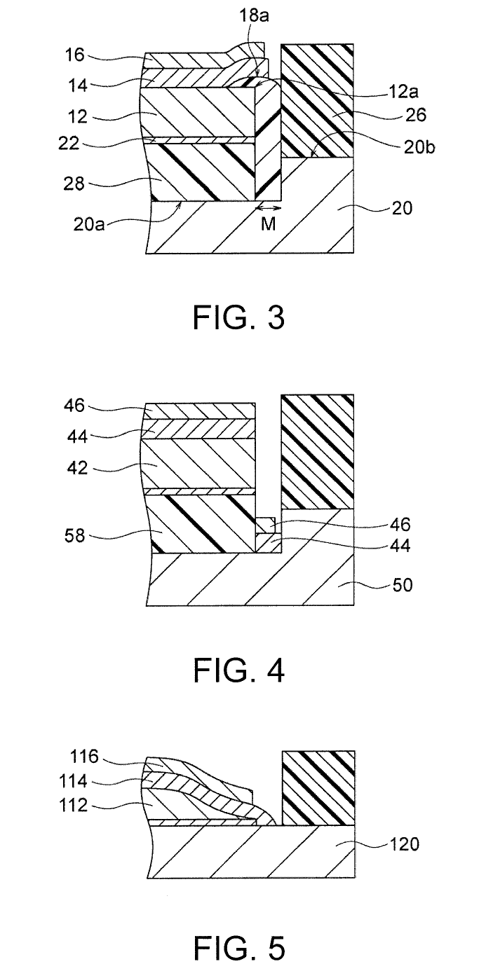

The end insulator 18 insulates and coats ends of the oriented positive electrode plate 12 and has a structure as described above. The end insulator 18 may be disposed such that a step exists between the end insulator 18 and the surface of the oriented positive electrode plate 12 adjacent the solid electrolyte layer 14 or such that such a step is not present. A case of not forming a step is preferred than a case of forming a step, in view of more certainly preventing short-circuiting and easiness in the production. In this case, as shown in FIG. 3, the end insulator 18 preferably has a raised portion 18a whose height is higher than the surface of the oriented positive electrode plate 12 adjacent the solid electrolyte layer 14, and the corner 12a of the oriented positive electrode plate 12 adjacent the solid electrolyte layer 14 is preferably buried in the raised portion 18a. In such a case, defects of the solid electrolyte layer 14, which may occur due to a local decrease in the film-forming ability caused by the corner of the oriented positive electrode plate 12, can be further certainly prevented to further effectively prevent short-circuiting at the upper portion of the end of the oriented positive electrode plate 12.

The end insulator 18 preferably contains an organic polymer material that can adhere to or come into direct contact with the oriented positive electrode plate 12. The end insulator 18 containing such an organic polymer material can more effectively prevent short-circuiting between the oriented positive electrode plate 12 and the negative electrode layer 16 and relieve the stress caused by expansion of the oriented positive electrode plate 12 during a charging operation. The organic polymer material is preferably at least one selected from the group consisting of binders, heat meltable resins, and adhesives. Preferred examples of the binder include cellulose resins, acrylic resins, and combinations thereof. Preferred examples of the heat meltable resin include fluororesins, polyolefin resins, and combinations thereof. The heat meltable resin is preferably supplied in the form of a heat-melting film as described below. Preferred examples of the adhesive include thermosetting adhesives containing thermosetting resins, such as epoxy resins. Accordingly, the organic polymer material is preferably at least one selected from the group consisting of cellulose resins, acrylic resins, fluororesins, polyolefin resins, and epoxy resins. Examples of the cellulose resin include carboxymethyl cellulose, carboxyethyl cellulose, hydroxyethyl cellulose, hydroxypropyl cellulose, cellulose butyrate, cellulose acetate butyrate, and their alkali metal salts and ammonium salts. Examples of acrylic resin include polyacrylic esters, polyacrylates, and their maleic anhydride modified products, maleic acid modified products, and fumaric acid modified products. Examples of the fluororesin include poly(vinylidene fluoride) (PVdF), polytetrafluoroethylene (PTFE), tetrafluoroethylene-perfluoalkyl vinyl ether copolymers (PFA), tetrafluoroethylene-hexafluoropropylene copolymers (FEP), polychlorotrifluoroethylene (PCTFE), tetrafluoroethylene-hexafluoropropylene-vinylidene fluoride copolymers, hexafluoropropylene-vinylidene fluoride copolymers, and their maleic anhydride modified products, maleic acid modified products, and fumaric acid modified products. Examples of the polyolefin resin include polyethylene, polypropylene, cycloolefin polymers, and their maleic anhydride modified products, maleic acid modified products, and fumaric acid modified products.

The end insulator 18 preferably further contains a filler, in addition to the organic polymer material (preferably a binder). Preferred examples of the filler include organic fillers composed of organic materials and/or inorganic fillers composed of inorganic materials. Preferred examples of the organic material constituting the organic filler include polytetrafluoroethylene (PTFE), tetrafluoroethylene-perfluoroalkyl vinyl ether copolymers (PFA), tetrafluoroethylene-hexafluoropropylene copolymers (FEP), polypropylene (PP), cycloolefin polymers, and their combinations. Preferred examples of the inorganic material constituting the inorganic filler include silica, alumina, zirconia, and their combinations. The filler preferably has a grain size such that the filler can enter the gap between the oriented positive electrode plate 12 and the positive electrode cladding 20 (in particular, protrusion 20b), and the grain size is preferably within a range of 0.1 to 10 μm and more preferably within a range of 0.1 to 10 μm.

The end insulator 18 is preferably formed by application of a solution or slurry containing an organic polymer material (preferably a binder) and optional components, such as a filler. The solution or slurry is preferably applied by, for example, dispensing, screen printing, spraying, or stamping. Alternatively, the end insulator 18 may be formed by affixing of a film containing an organic polymer material and optional components, such as a filler, and subsequent melting. The affixing of a film containing an organic polymer material is preferably performed by heat sealing. Examples of the film suitable for such application include the heat-melting films containing heat melting resins as described above. The formation of the end insulator 18 by affixing of a film and subsequent melting is preferably performed by affixing a film (e.g., heat sealing film) in a region of the oriented positive electrode plate 12 ranging from the surface in the vicinity of the end to the side surface at the end and then heating and melting the film. Thus, the melted film sufficiently coats the surface of the end and the side surface at the end of the oriented positive electrode plate 12.

### Cladding

The all-solid-state lithium battery 10 is preferably provided with a positive electrode cladding 20 made of a metal that coats the outside of the oriented positive electrode plate 12 and also functions as a positive electrode current collector. The all-solid-state lithium battery 10 is preferably provided with a negative electrode cladding 24 made of a metal that coats the outside of the negative electrode layer 16 and also functions as a negative electrode current collector. As shown in FIG. 1, the all-solid-state lithium battery 10 may have a structure where two unit cells are stacked with vertical symmetry with respect to one negative electrode cladding 24 therebetween to expose the positive electrode cladding 20 to the outside of the all-solid-state lithium battery 10. Alternatively, two unit cells may be stacked with vertical symmetry with respect to one positive electrode cladding therebetween to expose the negative electrode cladding to the outside of the all-solid-state lithium battery. In such a battery composed of cells stacked in parallel, the positive electrode cladding 20 or the negative electrode cladding 24 can function as a current collector common to two adjacent unit cells.

The positive electrode cladding 20 and the negative electrode cladding 24 may be composed of the same material or different materials and are preferably composed of the same material. The metal constituting the positive electrode cladding 20 and the negative electrode cladding 24 may be any metal or alloy that does not react with the oriented positive electrode plate 12 and the negative electrode layer 16. Preferred examples of such a metal include stainless steel, aluminum, copper, platinum, and nickel, and stainless steel is more preferred. The positive electrode cladding 20 and the negative electrode cladding 24 are preferably metal plate or metal foil and more preferably metal foil. Accordingly, the most preferred cladding is stainless steel foil. The metal foil preferably has a thickness of 1 to 30 μm, more preferably 5 to 25 μm, and most preferably 10 to 20 μm.

According to a preferred embodiment of the present invention, the oriented positive electrode plate 12 is bonded to the positive electrode cladding 20 with a conductive adhesive 28. Immobilization of the oriented positive electrode plate 12 to a substrate, such as the positive electrode cladding 20, with a conductive adhesive 38 electrically connects the oriented positive electrode plate 12 to the positive electrode cladding 20 and also enhances the workability in the subsequent process (e.g., formation of an end insulator 18 or a solid electrolyte layer 14). A conductive adhesive allows the positive electrode cladding 20 to certainly function as a positive electrode current collector. The layer of the conductive adhesive 28 preferably has a thickness of 5 to 100 μm and more preferably 10 to 50 μm. In such a case, the electron conductivity between the conductive adhesive 28 and the oriented positive electrode plate 12 may be enhanced by disposing a thin metal layer 22 between the oriented positive electrode plate 12 and the conductive adhesive 28. The thin metal layer 22 may be composed of any metal that shows a low electron conduction resistance for the conductive adhesive 28 and the oriented positive electrode plate 12, has a low reactivity with the conductive adhesive 28, and does not disadvantageously affect the characteristics of the oriented positive electrode plate 12. Preferred examples of the thin metal layer include a sputtered Au layer. The thin metal layer 22, such as a sputtered Au layer, preferably has a thickness of 10 to 1000 nm and more preferably 50 to 500 nm.

According to another preferred embodiment of the present invention, the oriented positive electrode plate 12 may be directly placed on the positive electrode cladding 20 without being immobilized to, for example, the conductive adhesive 28. In also such a case, the oriented positive electrode plate 12 is in direct contact with the positive electrode cladding 20, and the positive electrode cladding 20 can certainly function as a positive electrode current collector. That is, this embodiment is based on the present finding that electrical connection between the oriented positive electrode plate 12 and the positive electrode cladding 20 is sufficiently achieved by mere contact (without using, for example, a conductive adhesive 28). In particular, an improvement in the production process can produce an all-solid-state lithium battery without immobilizing the oriented positive electrode plate 12 to a substrate, such as the positive electrode cladding 20. Also in this embodiment, a thin metal layer 22 may be disposed between the oriented positive electrode plate 12 and the positive electrode cladding 20 to enhance the electron conductivity between the positive electrode cladding 20 and the oriented positive electrode plate 12. The thin metal layer 22 may be composed of any metal that shows a low electron conduction resistance for the oriented positive electrode plate 12 and does not disadvantageously affect the characteristics of the oriented positive electrode plate 12. Preferred examples of the thin metal layer include a sputtered Au layer. The thin metal layer 22, such as a sputtered Au layer, preferably has a thickness of 10 to 1000 nm and more preferably 50 to 500 nm.

The positive electrode cladding 20, preferably a metal plate or metal foil, is preferably provided with a counterbored depression 20a partitioning the region where a stacked product composed of an oriented positive electrode plate 12, a solid electrolyte layer 14, and a negative electrode layer 16 is disposed and forming a frame-like protrusion 20b in the circumference of the depression 20a. The counterbored depression 20a preferably has a slight margin M so as to accept expansion of the oriented positive electrode plate 12 and/or the negative electrode layer 16, and the margin M is preferably filled with the end insulator 18 without a clearance. Consequently, short-circuiting between the oriented positive electrode plate and the negative electrode layer can be further effectively prevented, while further certainly relieving the stress caused by expansion of the oriented positive electrode plate during a charging operation. The depression 20a preferably has a depth of 10 to 500 μm and more preferably 20 to 300 μm. The protrusion 20b preferably has a thickness of 15 to 600 μm and more preferably 30 to 400 μm. The distance (margin) M between the end of the oriented positive electrode plate 12 and the frame-like protrusion 20b is preferably 0.1 to 1.1 mm and more preferably 0.1 to 0.6 mm. The negative electrode cladding 24 may also be provided with a counterbored depression 20a and a frame-like protrusion 20b in the circumference of the depression 20a, as in the positive electrode cladding 20.

### End Seal

The all-solid-state lithium battery 10 preferably further includes an end seal 26 composed of a sealing material. The end seal 26 seals the exposed portions of the oriented positive electrode plate 12, the solid electrolyte layer 14, the negative electrode layer 16, and the end insulator 18 without being coated with the positive electrode cladding 20 and the negative electrode cladding 24. High resistance to humidity (desirably resistance to humidity at high temperature) can be achieved by disposing the end seal 26 so as to seal the exposed portions of the oriented positive electrode plate 12, the solid electrolyte layer 14, the negative electrode layer 16, and the end insulator 18 without being coated with the positive electrode cladding 20 and the negative electrode cladding 24. As a result, undesired moisture can be effectively prevented from infiltrating into the all-solid-state lithium battery 10, leading to an improvement in battery characteristics. The end seal 26 is composed of a sealing material. Although the sealing material may be any material that can seal the exposed portions not coated with the positive electrode cladding 20 and the negative electrode cladding 24 and the end insulator 18 to achieve high resistance to humidity (desirably resistance to humidity at high temperature), the sealing material should achieve electrical insulation between the positive electrode cladding 20 and the negative electrode cladding 24. In this reason, the sealing material preferably has a resistivity of 1×10⁶ Ωcm or more, more preferably 1×10⁷ Ωm or more, and most preferably 1×10⁸ Ωcm or more. Such a resistivity can significantly reduce the self-discharge.

The end seal 26 preferably has a thickness of 10 to 300 μm, more preferably 15 to 200 μm, and most preferably 20 to 150 μm. In the case where the battery is coated with a positive electrode cladding and a negative electrode cladding made of metals, since the positive electrode cladding and the negative electrode cladding do not infiltrate moisture, infiltration of moisture into the battery is caused only by permeation through the end seal 26. Accordingly, a decrease in the thickness of the end seal 26 (i.e., a reduction in the area of inlet for moisture to infiltrate) or an increase in the width of the end seal 26 (i.e., an increase in the path for moisture to infiltrate) decreases the amount of moisture infiltrated into the battery, namely, improves the resistance to humidity. The thickness within the above-mentioned range is preferred from such a viewpoint.

The width of the end seal 26 (in other words, the thickness of the end seal 26 in the direction of the surface of the solid electrolyte layer 14) is preferably 0.5 to 3 mm, more preferably 0.7 to 2 mm, and most preferably 1 to 2 mm. A width within the above-mentioned range can achieve a high volume energy density of the battery without excessively enlarging the end seal 26.

The sealing material is preferably a resin sealing material containing a resin. In such a case, the end seal 26 can be formed at a relatively low temperature (e.g., 400° C. or less). As a result, the battery can be effectively prevented from destruction or deterioration caused by sealing with heating. The resin preferably has a coefficient of thermal expansion of 7×10⁻⁶/° C. or more, more preferably 9×10⁻⁶ to 20×10⁻⁶/° C., more preferably 10×10⁻⁶ to 19×10⁻⁶/° C., more preferably 12×10⁻⁶ to 18×10⁻⁶/° C., and most preferably 15×10⁻⁶ to 18×10⁻⁶/° C. The resin is preferably an insulative resin. The insulative resin is preferably adhesive while maintaining the insulative property (e.g., thermal adhesive resin). Preferred examples of the insulative resin include olefin resins, fluororesins, acrylic resins, epoxy resins, urethane resins, and silicon resins. Particularly preferred examples of the resin are low moisture permeable resins serving as sealing materials and include adhesive resins having heat sealing properties and low moisture permeability, such as polypropylene (PP), polyethylene (PE), cycloolefin polymers, polychlorotrifluoroethylene (PCTFE), and their maleic anhydride modified products, maleic acid modified products, and fumaric acid modified products. The insulative resin may be composed of one or more stacked products. At least one insulative resin may be a thermoplastic resin-molded sheet. The resin sealing material may be a mixture of a resin (preferably an insulative resin) and an inorganic material. Preferred examples of the inorganic material include silica, alumina, zinc oxide, magnesia, calcium carbonate, potassium hydroxide, barium sulfate, mica, and talc. More preferably, the inorganic material is silica. For example, a resin sealing material composed of an epoxy resin and silica is preferred.

The end seal 26 may be formed by, for example, lamination of resin films or dispensing of a liquid resin. The gap formed between the end sides of the oriented positive electrode plate 12, the solid electrolyte layer 14, and the negative electrode layer 16 and the end seal 26 is preferably sufficiently filled with the end insulator 18. In the positive electrode cladding 20 provided with a counterbored depression 20a and a frame-like protrusion 20b in the circumference of the depression 20a as shown in FIG. 3, the end seal 26 is preferably disposed between the frame-like protrusion 20b and the negative electrode cladding 24. In such a case, the end seal 26 can have a reduced area, leading to more effective prevention of infiltration of moisture to further improve the resistance to humidity.

Alternatively, the sealing material may be a glass sealing material containing glass. The glass sealing material preferably contains at least one element selected from the group consisting of V, Sn, Te, P, Bi, B, Zn, and Pb from the view of readily achieving desired softening temperature and coefficient of thermal expansion. These elements are present in glass in the forms of V₂O₅, SnO, TeO₂, P₂O₅, Bi₂O₃, B₂O₃, ZnO, and PbO. The glass sealing material preferably does not contain Pb and PbO that may be harmful. The glass sealing material preferably has a softening temperature of 400° C. or less, more preferably 370° C. or less, and most preferably 350° C. or less. Although the softening temperature has no lower limit, the lower limit can be, for example, 300° C. or more, 310° C. or more, or 320° C. or more. The use of a glass sealing material having a relatively low softening temperature allows the end seal 26 to be formed at a relatively low temperature. As a result, the battery can be effectively prevented from destruction or deterioration caused by sealing with heating. The glass sealing material preferably has a coefficient of thermal expansion of 7×10⁻⁶/° C. or more, more preferably 9×10⁻⁶ to 20×10⁻⁶/° C., more preferably 10×10⁻⁶ to 19×10⁻⁶/° C., more preferably 12×10⁻⁶ to 18×10⁻⁶/° C., and most preferably 15×10⁻⁶ to 18×10⁻⁶/° C. Since the coefficient of thermal expansion within such a range is similar to that of a metal, the damage caused by a thermal shock at the joint of the cladding made of a metal (i.e., the positive electrode cladding 20 and/or the negative electrode cladding 24) and the end seal 26 can be effectively prevented. Glass sealing materials satisfying the above-described characteristics are commercially available. Examples of the glass sealing materials satisfying the above-described characteristics include “POWDER GLASS” (AGC glass frit) and “GLASS PASTE” (AGC glass paste) product families available from AGC Electronics Co., Ltd., a Low Melting Point Glass Paste product family available from Central Glass Co., Ltd., and a “Vaneetect” product family of vanadium-based low-melting-point glass available from Hitachi Chemical Co., Ltd.

### Thickness of Battery

The all-solid-state lithium battery including one unit cell preferably has a thickness of 60 to 5000 μm, more preferably 70 to 4000 μm, more preferably 80 to 3000 μm, more preferably 90 to 2000 μm, and most preferably 100 to 1000 μm. According to the present invention, the battery can have a relatively small thickness, whereas the oriented positive electrode plate can have a relatively large thickness, because the cladding also functions as a current collector.

### Production of Positive-Electrode Active Material Sheet

A preferred method of preparing the positive-electrode active material sheet will now be described.

### (1) Preparation of Base Particles

The base particles are prepared by appropriately mixing particles of compounds containing, for example, Li, Co, Ni, Mn, and Al, such that the positive-electrode active material has a composition LiMO₂ after synthesis and a layered rock-salt structure. Alternatively, the base particles may have a composition LiMO₂ (may be already synthesized).

Alternatively, base particles free from a lithium compound may be used as necessary. In this case, after the firing process of a green body, the fired body is further reacted with a lithium compound to yield LiMO₂. Examples of the lithium-free base particles include mixed particles of compounds of, for example, Co, Ni, Mn, and Al (mixed particles having compositions such as (Co,Ni,Mn)Oₓ, (Co,Ni,Al)Oₓ, (Co,Ni,Mn)OHₓ, and (Co,Ni,Al)OHₓ). Preferably, at least one metal compound is an oxide, hydroxide, and/or carbonate of at least one metal selected from the group consisting of Co, Ni, Mn, and Al. These particles may be in a form of a powder mixture of two or more types of metal compound particles or may be composed of a composite compound synthesized by coprecipitation.

To promote the grain growth and to compensate for the volatilized component during the firing process, a lithium compound may be added in an excess amount of 0.5 to 30 mol %. To promote the grain growth, low-melting oxide, such as bismuth oxide, or low-melting glass, such as borosilicate glass, may be added in an amount of 0.001 to 30 wt %.

### (2) Base-Particle Shaping Process

The base particles are formed into a sheet-like self-supporting green body. Typically, the “self-supporting green body” maintains its shape as a sheet by itself. However, the “self-supporting green body” also includes a green body that cannot maintain its shape as a sheet by itself but is affixed or deposited on a substrate and then peeled from the substrate before or after firing.

The green body may be formed, for example, by a doctor blade process that uses slurry containing the base particles. Alternatively, the process of forming the green body may be performed with a drum dryer, with which base-material-containing slurry is applied onto a heated drum to be dried thereon, and the dried product is scraped off with a scraper. A disc dryer may be used, with which the slurry is applied onto a heated disk surface to be dried thereon, and the dried product is scraped off with a scraper in the process of forming the green body. Hollow granules produced under properly determined conditions of the spray dryer are regarded as a curved sheet-like green body and thus may be suitably used as a green body. The green body may be formed by an extrusion molding process that uses a slurry mixture containing the base particles.

In the doctor blade process, the green body of the platy polycrystalline particles before firing may be prepared by applying slurry onto a flexible plate (for example, an organic polymer plate, such as a PET film), drying and solidifying the applied slurry in the form of a green body, and peeling the green body from the plate. In the preparation of the slurry or slurry mixture before shaping, inorganic particles may be dispersed in an appropriate dispersion medium, and a binder or plasticizer may be added if needed. Preferably, the slurry is prepared so as to have a viscosity of 500 to 4000 cP and is defoamed under a reduced pressure.

### (3) Firing Process of Green Body

In this firing process, the green body produced in the shaping process is placed on a setter and fired, for example, in the state as it is shaped (the sheet state). Alternatively, in the firing process, the sheet-like green body may be properly cut or pulverized and then fired in a sagger.

The mixed particles before synthesis, if used as the base particles, result in sintering and grain growth in addition to synthesis in this firing process. In the present invention, the green body has a sheet shape, which limits grain growth in the thickness direction. Thus, after the grain growth into one crystal grain in the thickness direction of the green body, the grain growth proceeds only in the in-plane direction of the green body. At this time, the specific energy-stable crystal face spreads over the sheet surface (plate surface). In this way, a film-like sheet (self-supporting film) is produced in which the specific crystal face is oriented in parallel with the sheet surface (plate surface).

If the base particles are LiMO₂, the crystal faces favorable for the intercalation and deintercalation of lithium ions, i.e., the (101) and (104) planes, are oriented so as to be exposed to the sheet surface (plate surface). If the base particles do not contain lithium (for example, M₃O₄ having a spinel structure), the (h00) plane, which will be the (104) plane after the reaction with a lithium compound to yield LiMO₂, is oriented so as to be exposed to the sheet surface (plate surface).

The firing temperature is preferably in the range of 700 to 1350° C. A temperature lower than 700° C. causes insufficient grain growth and a low degree of orientation. A temperature higher than 1350° C. accelerates decomposition and volatilization. The firing time is preferably 1 to 50 hours. A time less than one hour causes a low degree of orientation. A time exceeding 50 hours consumes excess energy. The firing atmosphere is properly determined so as to prevent decomposition during the firing. If lithium volatilization proceeds, it is preferred to dispose, for example, lithium carbonate in the same sagger to keep a lithium atmosphere. If oxygen release and further reduction proceed during the firing, it is preferred to fire the green body in an atmosphere under a high oxygen partial pressure.

If the sheet oriented by the firing is produced from the base particles not containing lithium compounds, the sheet is allowed to react with a lithium compound (such as lithium nitrate and lithium carbonate) to produce a positive-electrode active material film in which the crystal faces favorable for the intercalation and deintercalation of lithium ions are oriented so as to be exposed to the plate surface. For example, lithium nitrate is sprinkled over the oriented sheet, such that the molar ratio Li/M of Li to M is 1 or more, and the sheet is heat-treated to incorporate lithium. The heat-treatment temperature is preferably in the range of 600 to 800° C. A temperature lower than 600° C. causes insufficient reaction. A temperature higher than 900° C. causes a low degree of orientation.

(Preparation Example of Positive-electrode Active Material Sheet with Preferred Composition)

The positive-electrode active material sheet containing Liₚ(Niₓ,Co_{y},Al_{z})O₂ or Liₚ(Niₓ,Co_{y},Mn_{z})O₂ grains may prepared, for example, by the following process. A green sheet containing NiO powder, Co₃O₄ powder, and AlOOH or Mn₃O₄ powder is formed and then fired at a temperature in the range of 1000 to 1400° C. in the atmosphere for a predetermined time to form an independent film-like sheet (self-supporting film) composed of a large number of (h00)-oriented platy (Ni,Co,Al)O or (Ni,Co,Mn)O grains. An agent, such as MnO₂ and ZnO, can be added to promote the grain growth and thus to increase the degree of (h00)-orientation of the platy crystalline grains. The “independent” sheet indicates a sheet that can be handled alone separately from a support after the firing. That is, the “independent” sheet does not include a sheet fixed to and integrated with (nor readily separable from) a support (such as a substrate) by firing. In such a green sheet formed into a self-supporting film, the amount of materials present in the thickness direction is significantly smaller than that in the plate-surface direction, i.e., the in-plane direction (the direction orthogonal to the thickness). Thus, in the early stage, multiple grains are present in the thickness direction, and the grain growth occurs in a random direction. After the grain growth proceeds and the materials in the thickness direction are consumed, the grain growth is limited to the in-plane, i.e., two-dimensional direction. This ensures the promotion of the grain growth in the surface direction. Even in a relatively thick green sheet having a thickness of approximately 100 μm or more, the grain growth in the surface direction is ensured by promoting the grain growth as high as possible. That is, the surface-directional grain growth is promoted preferentially in grains having the low-surface-energy face parallel to the plate surface direction, i.e., the in-plane direction (the direction orthogonal to the thickness). The green sheet formed into a film is fired to produce a self-supporting film in which a large number of flaky grains having the specific crystal face oriented in parallel with the grain plate surfaces are bonded to each other at grain boundaries in the surface direction. That is, a self-supporting film is formed that substantially has one crystalline grain in the thickness direction. It should be noted that “a self-supporting film that substantially has one crystalline grain in the thickness direction” does not exclude a film that has portions (for example, ends) of crystalline grains adjacent to each other in the surface direction overlapping each other in the thickness direction. The self-supporting film can be a dense ceramic sheet containing a large number of flaky grains closely bonded to each other, as described above. The (h00)-oriented (Ni,Co,Al)O or (Ni,Co,Mn)O ceramic sheet produced in the above-described process is mixed with lithium nitrate (LiNO₃), and the mixture is then heated for a predetermined time, thereby introducing lithium into the (Ni,Co,Al)O or (Ni,Co,Mn)O grains. This provides a film-like Liₚ(Niₓ,Co_{y},Al_{z})O₂ or Liₚ(Niₓ,Co_{y},Mn_{z})O₂ sheet for the oriented positive-electrode plate 12 with the (003) plane oriented in the direction from the oriented positive-electrode plate 12 toward the negative electrode layer 16 and the (104) plane oriented along the plate surface.

### Production of Lithium-ion Conductive Material

A preferred method of preparing an Al-containing LLZ ceramic sintered body, which is a typical lithium-ion conductive material of the solid electrolyte layer 14, will now be described.

In the first firing process, a raw material containing a Li component, a La component, and a Zr component is fired to produce primary fired powder that contains Li, La, Zr, and O for synthesis of a ceramic. Then, in the second firing process, the primary fired powder produced in the first firing process is fired to produce a synthetic ceramic that contains Li, La, Zr, and O and has a garnet-type or pseudo-garnet-type crystal structure. This readily provides ceramic powder or sintered body that has an LLZ crystal structure, and contains aluminum that produces handleable sintering properties (density) and conductivity.

### (Li Component, La Component, and Zr Component)

These components each may be appropriately selected from metal oxides, metal hydroxides, metal carbonates, and other metal salts that contain the metal components described above. For example, the Li component may be Li₂CO₃ or LiOH, the La component may be La(OH)₃ or La₂O₃, and the Zr component may be ZrO₂. Oxygen is typically contained as an element constituting compounds containing these metal constituents. A raw material to produce the ceramic material can contain a Li component, a La component, and a Zr component to such an extent as to yield the LLZ crystal structure from the Li, La, and Zr components by, for example, a solid phase reaction. The Li, La, and Zr components in LLZ can have a stoichiometric ratio of 7:3:2 or similar to that. In consideration of loss of the Li component, the Li component may be contained in an approximately 10% excess amount to the stoichiometric ratio of Li in LLZ, and the La and Zr components each may be contained in an amount equivalent to the molar ratio of the component in LLZ. For example, these components may be contained in a molar ratio, Li:La:Zr, of 7.7:3:2. The molar ratio of a specific compound is approximately 3.85:3:2 for Li₂CO₃:La(OH)₃:ZrO₂, approximately 3.85:1.5:2 for Li₂CO₃:La₂O₃:ZrO₂, approximately 7.7:3:2 for LiOH:La(OH)₃:ZrO₂, or approximately 7.7:1.5:2 for LiOH:La₂O₃:ZrO₂. The raw material powder may be prepared by an appropriate known raw powder preparation process for synthesis of ceramic powder. For example, the raw materials may be homogeneously mixed with an automated mortar machine or an appropriate ball mill.

### (First Firing Process)

In the first firing process, at least the Li and La components are pyrolyzed to produce primary fired powder for facilitating the formation of an LLZ crystal structure in the second firing process. The primary fired powder may preliminarily have an LLZ crystal structure. The firing temperature is preferably 850° C. or higher and 1150° C. or lower. The first firing process may include one or more low temperature heating steps and one or more high-temperature heating steps within the temperature range. These heating steps help to produce uniform ceramic powder and a high-quality sintered body in the second firing process. After each of these multiple heating steps, if performed in the first firing process, the fired product is preferably kneaded and ground with, for example, an automated mortar machine, a ball mill, or a vibration mill. Dry grinding is desirable. These steps help to yield a more uniform LLZ phase in the second firing process. The heating steps of the first firing process are preferably performed at 850° C. or higher and 950° C. or lower and at 1075° C. or higher and 1150° C. or lower. More preferably, the steps are performed at 875° C. or higher and 925° C. or lower (most preferably at approximately 900° C.) and at 1100° C. or higher and 1150° C. or lower (most preferably at approximately 1125° C.). In the first firing process, the total heating time at the maximum temperature determined as a heating temperature is preferably approximately 10 hours or more and 15 hours or less. If the first firing process includes two heating steps, the heating time at the maximum temperature is preferably in the range of approximately 5 to 6 hours in each step. A change of one or more components in the starting material can reduce the time required for the first firing process. For example, if LiOH is used as one component contained in the starting material, the time to heat the LLZ constituents containing Li, La, and Zr at the maximum temperature can be 10 hours or less in a heating step at 850° C. or higher and 950° C. or lower to yield an LLZ crystal structure. This is because LiOH used in the starting material forms a liquid phase at a low temperature and thus readily reacts with other components at a lower temperature.

### (Second Firing Process)

In the second firing process, the primary fired powder produced in the first firing process is heated at 950° C. or higher and 1250° C. or lower. In the second firing process, the primary fired powder produced in the first firing process is fired to produce a final ceramic product that is a complex oxide having an LLZ crystal structure. To yield such an LLZ crystal structure, for example, the LLZ constituents containing Li, La, and Zr are heated at 1125° C. or higher and 1250° C. or lower. If Li₂CO₃ is used as a Li component, heating is preferably performed at 1125° C. or higher and 1250° C. or lower. A temperature lower than 1125° C. may prevent the formation of a single LLZ phase and causes low Li conductivity, and a temperature higher than 1250° C. may cause formation of a heterogeneous phase (such as La₂Zr₂O₇) and causes low Li conductivity and significant crystal growth which fail to maintain the strength as a solid electrolyte. More preferably, the heating temperature is in the range of approximately 1180 to 1230° C. A change of one or more components in the starting material allows the second firing process to be performed at a lower temperature. For example, if LiOH is used as a Li component in the starting material, the LLZ constituents containing Li, La, and Zr may be heated at 950° C. or higher and lower than 1125° C. to yield an LLZ crystal structure. This is because LiOH used in the starting material forms a liquid phase at a low temperature and thus readily reacts with other components at a lower temperature. In the second firing process, the heating time at the heating temperature is preferably 18 hours or more and 50 hours or less. A time less than 18 hours causes insufficient formation of the LLZ-based ceramic, and a time exceeding 50 hours may cause the material to readily react with the setter through embedding powder and causes significant crystal growth, thus failing to achieve strength required for the sample. More preferably, the heating time is at least 30 hours. The second firing process is preferably performed after the primary fired powder is pressed by a known pressing process into a green body having a desired three-dimensional shape (for example, such a shape and size as to be used as the solid electrolyte of the all-solid-state lithium battery). The green body of the primary fired powder promotes a solid phase reaction and provides a sintered body. After the second firing process, the ceramic powder produced in the second firing process may be formed into a green body and then additionally fired at a temperature similar to the heating temperature in the second firing process. If the green body of the primary fired powder is fired to be sintered in the second firing process, the second firing process is preferably performed with the green body buried into the same powder. This reduces loss of Li and a variation in the composition between before and after the second firing process. The green body of the raw powder is typically placed on the raw powder and then buried into the raw powder. This reduces reaction with the setter. If necessary, the green body may be held with the setter through the embedding powder placed on both sides of the green body to prevent warpage of the sintered body during the firing. If the second firing process is performed at a lower temperature with LiOH used as a Li component, the green body of the primary fired powder can be sintered without being buried into the powder. This is because a lower temperature in the second firing process relatively reduces the loss of Li and reaction with the setter.

The use of a powder resulting from the above firing processes can produce a solid electrolyte layer 14 having an LLZ crystal structure. The first firing process and/or second firing process may be performed in the presence of an aluminum (M-containing compound to produce a solid electrolyte layer that has a crystal structure and contains aluminum.

### EXAMPLES

The present invention will now be described more in detail with reference to the following examples.

### Examples 1 to 18

In each of Examples 1 to 18, an oriented positive electrode plate and an all-solid-state lithium battery were produced and the yield of the battery was evaluated as follows.

### (1) Preparation of Oriented Positive Electrode Plate

### (1a) Preparation of Green Sheet

Bi₂O₃ (volume-based D50 particle diameter: 0.3 μm, manufactured by Taiyo Koko Co., Ltd.) in an amount of 10 wt % was added to a Co₃O₄ raw material powder (volume-based D50 particle diameter: 0.3 μm, manufactured by Seido Chemical Industry Co., Ltd.) into a powder mixture. A mixture composed of 100 parts by weight of this powder mixture, 100 parts by weight of a dispersion medium (toluene:isopropanol=1:1), 10 parts by weight of a binder (polyvinyl butyral: Product No. BM-2, manufactured by Sekisui Chemical Co., Ltd.), 4 parts by weight of a plasticizer (DOP: di(2-ethylhexyl)phthalate, manufactured by Kurogane Kasei Co., Ltd.), and 2 parts by weight of a dispersant (Product Name: Leodol SP-O30, manufactured by Kao Corporation) was prepared. This mixture was stirred under reduced pressure for defoaming and to adjust the viscosity to 4000 cP. The viscosity during the preparation was measured with an LVT viscometer manufactured by Brookfield. The resulting slurry was applied onto polyethylene terephthalate (PET) film by doctor blading and was dried into a green sheet having a dry thickness of 24 μm.

(1b) Preparation of Co₃O₄ Oriented Fired Plate

The green sheet was peeled from the PET film and cut into a 50 mm square with a cutter. The cut piece was placed on the center of a zirconia setter (size: 90 mm square, height: 1 mm) having embossed raised portions of 300 μm and fired at 1300° C. for 5 hours. The cut piece was cooled at a rate of 50° C./h, and a portion of the fired piece not adhering to the setter was taken out as a Co₃O₄ oriented fired plate.

### (1c) Preparation of Lithium Cobaltate Oriented Fired Plate

A LiOH.H₂O powder (manufactured by Wako Pure Chemical Industries, Ltd.) was pulverized to 1 μm or less with a jet mill and was dispersed in ethanol into slurry. This slurry was applied onto the Co₃O₄ oriented fired plate so as to give a ratio Li/Co of 1.3 and the plate was dried. The dried product was then heated in air at 840° C. for 10 hours to incorporate lithium into the Co₃O₄ oriented fired plate. A lithium cobaltate oriented fired plate, as an oriented positive electrode plate, of LiCoO₂ was thereby prepared.

### (1d) Evaluation of Lithium Cobaltate Oriented Fired Plate

The orientation of the (104) plane of LiCoO₂ was oriented in parallel to the plate surface among a plurality of crystal faces of the lithium cobaltate oriented fired plate was evaluated by an X-ray diffraction (XRD) analysis. In this analysis, an XRD apparatus Geigerflex RAD-IB (manufactured by Rigaku Corporation) was used, and the XRD profile was measured under irradiation of the surface of the fired plate with X-rays. The ratio I[003]/I[104] of the diffraction intensity (peak height) of the (003) plane to the diffraction intensity (peak height) of the (104) plane determined from the measured XRD profile was 0.3. The plate was then sufficiently pulverized in a mortar into a powder, and the XRD profile of the powder was measured. The ratio I[003]/I[104] was 1.6. The results demonstrate that a large number of (104) planes of LiCoO₂ were present in parallel to the plate surface, that is, a desired degree of orientation suitable for a high-capacity lithium secondary battery was provided.

### (2) Production of All-Solid-State Lithium Battery

In an all-solid-state lithium battery having a structure as shown in FIG. 1, a lower half of the all-solid-state lithium battery, which corresponds to the unit cell under the negative electrode cladding, was produced as follows.

### (2a) Preparation of Thin Metal Layer

An Au layer having a thickness of 1000 angstrom was formed on one surface of a lithium cobaltate oriented positive electrode plate 12 by sputtering with an ion sputtering system JFC-1500 (manufactured by JEOL Ltd.) into a thin metal layer 22.

### (2b) Immobilization of Oriented Positive Electrode Plate

A stainless steel current collector (positive electrode cladding 20) having a counterbored depression 20a and a frame-like protrusion 20b in the circumference of the depression 20a as shown in FIG. 3 was prepared. The thin metal layer 22 of the lithium cobaltate oriented fired plate was immobilized on the counterbored depression 20a of the stainless steel current collector (positive electrode cladding 20) with an epoxy conductive adhesive 28 containing dispersed conductive carbon. A stacked plate composed of an oriented positive electrode plate 12, a thin metal layer 22, a conductive adhesive 28, and a positive electrode cladding 20 was thereby prepared.

(2c) Production of End Insulator (only Examples 2 to 18)

In each of Examples 2 to 13, 17, and 18, an organic polymer and/or a filler shown in Table 1 was dispersed in a dimethyl ether solvent. The resulting dispersion was applied to ends of the oriented positive electrode plate 12 and the plate was dried at 120° C. for removing the dimethyl ether into an end insulator 18. In each of Examples 14 to 16, an organic polymer film shown in Table 1 was pasted to the oriented positive electrode plate 12 from the surface near the end to the end side, followed by heating at 200° C. to melt the film. The film was applied to the oriented positive electrode plate 12 from the surface near the end to the side surface at the end to produce an end insulator 18 so as to form one continuous surface with the surface of the oriented positive electrode plate 12 and to seal the side surface at the end of the oriented positive electrode plate 12. On this occasion, in Examples 2 to 16, as shown in FIG. 3, the end insulator 18 having a raised portion 18a whose height is higher than the surface of the oriented positive electrode plate 12 adjacent the solid electrolyte layer 14, and the corner 12a of the oriented positive electrode plate 12 adjacent the solid electrolyte layer 14 was buried in the raised portion 18a. In Example 17, the end insulator 18 was produced such that the height of the surface of the end insulator 18 adjacent the solid electrolyte layer 14 was the same as that of the surface of the oriented positive electrode plate 12 adjacent the solid electrolyte layer 14, and the side face of the corner 12a of the oriented positive electrode plate 12 adjacent the solid electrolyte layer 14 was buried in the end insulator 18. In Example 18, the end insulator 18 was produced such that the height of the surface of the end insulator 18 adjacent the solid electrolyte layer 14 was lower than that of the surface of the oriented positive electrode plate 12 adjacent the solid electrolyte layer 14 by 0.5 In Example 1, for comparison, the end insulator was not formed.

### (2d) Formation of Solid Electrolyte Layer

A lithium phosphate sintered target having a dimeter of 4 inch (about 10 cm) was prepared. A gas species N₂ was brought into collision against this target at 0.2 Pa and an output of 0.2 kW by RF magnetron sputtering using a sputtering system SPF-430H (manufactured by Canon Anelva Corporation) to form a thin film on the surface of the oriented positive electrode plate. A sputtered solid electrolyte layer 14 of a lithium phosphate oxynitride glass electrolyte (LiPON) having a thickness of 3.5 μm was thereby formed on the oriented positive electrode plate 12.

### (2e) Formation of Negative Electrode Layer

A tungsten boat loaded with lithium metal was prepared. Li was evaporated by resistance heating with a vacuum deposition system Carbon Coater SVC-700 (manufactured by Sanyu Electron Co., Ltd.) and deposited into a thin film on the surface of the sputtered solid electrolyte film. An electric cell was thereby formed that had a deposited Li film as a negative electrode layer 16 having a thickness of 3.5 μm on the sputtered solid electrolyte film.

### (2f) Production of End Seal

A modified polypropylene resin film was laminated on the end of the electric cell to produce an end seal 26.

### (2g) Stacking of Negative Electrode Current Collector (Negative Electrode Cladding)

A stainless steel current collector as a negative electrode current collector (negative electrode cladding 24) was stacked on the negative electrode layer 16 of the electric cell and was pressure-bonded to the negative electrode layer 16 with a hot plate of 200° C. An all-solid-state lithium battery was thereby prepared.

In the above-described examples, the step (2b) (Immobilization of oriented positive electrode plate) was carried out immediately before the step (2c) (Production of end insulator). Alternately, the step (2b) may be carried out after the step (2c) and before any of the subsequent steps (i.e., between the steps (2c) and (2d), between the steps (2d) and (2e), between the steps (2e) and (2f), or between the steps (2f) and (2g)) or may be carried out after the step (2g).

### (3) Yield of All-Solid-State Lithium Battery

### (3a) Charge and Discharge Test

Twenty all-solid-state lithium batteries were produced for each Example as described above and were subjected to a charge and discharge test. In the charge and discharge test, the following charge and discharge cycle was carried out once.

### (Charge and Discharge Cycle)

Charging at a constant current of 0.1 mA up to 4.2V, then charging at a constant voltage up to 0.02 mA, and then discharging at a constant current of 0.02 mA down to 2.5 V were performed.

### (3b) Calculation of Yield

A battery had succeeded in the charge and discharge test was defined as a well charged and discharged battery, and the yield of the all-solid-state lithium battery in each Example was calculated from the following expression:

Yield (%)=(the number of well charged and discharged batteries)/(the number of produced batteries, i.e., 20)×100.

The results are shown in Table 1.

### Example 19

Another example of the production of an all-solid-state lithium battery will be described below.

(1) Production of oriented positive electrode plate

As in Examples 1 to 18, a lithium cobaltate oriented fired plate of LiCoO₂ was prepared as an oriented positive electrode plate.

### (2) Production of All-Solid-State Lithium Battery

In an all-solid-state lithium battery having a structure as shown in FIG. 1, a lower half of the all-solid-state lithium battery, which corresponds to the unit cell under the negative electrode cladding, was produced as follows.

### (2a) Production of Thin Metal Layer

An Au film having a thickness of 1000 angstrom was formed on one surface of a lithium cobaltate oriented positive electrode plate 12 by sputtering with an ion sputtering system JFC-1500 (manufactured by JEOL Ltd.) into a thin metal layer 22.

### (2b) Production of End Insulator

An organic polymer and a filler shown in Table 1 were dispersed in a dimethyl ether solvent. The resulting dispersion was applied to ends of the oriented positive electrode plate 12 and the plate was dried at 120° C. for removing the dimethyl ether to produce an end insulator 18.

### (2c) Formation of Solid Electrolyte Layer

A lithium phosphate sintered target having a dimeter of 4 inch (about 10 cm) was prepared. A gas species N₂ was brought into collision against this target at 0.2 Pa and an output of 0.2 kW by RF magnetron sputtering using a sputtering system SPF-430H (manufactured by Canon Anelva Corporation) to form a thin film on the surface of the oriented positive electrode plate. A sputtered solid electrolyte layer 14 of a lithium phosphate oxynitride glass electrolyte (LiPON) having a thickness of 3.5 μm was thereby formed on the oriented positive electrode plate 12.

### (2d) Formation of Negative Electrode Layer

A tungsten boat loaded with lithium metal was prepared. Li was evaporated by resistance heating with a vacuum deposition system Carbon Coater SVC-700 (manufactured by Sanyu Electron Co., Ltd.) and deposited into a thin film on the surface of the sputtered solid electrolyte film. An electric cell was thereby formed that had a deposited Li film as a negative electrode layer 16 having a thickness of 3.5 μm on the sputtered solid electrolyte film.

### (2e) Arrangement of Positive Electrode Cladding

A stainless steel current collector (positive electrode cladding 20) having a counterbored depression 20a and a frame-like protrusion 20b in the circumference of the depression 20a as shown in FIG. 3 was prepared. The electric cell was directly placed on the counterbored depression 20a of the stainless steel current collector (positive electrode cladding 20) such that the thin metal layer 22 was in contact with the current collector without disposing the conductive adhesive therebetween.

### (2f) Production of End Seal

A modified polypropylene resin film was laminated on the frame-like protrusion 20b at the end of the electric cell to produce the end seal 26.

### (2g) Stacking of Negative Electrode Current Collector (Negative Electrode Cladding)

A stainless steel current collector as a negative electrode current collector (negative electrode cladding 24) was stacked on the negative electrode layer 16 of the electric cell and was pressure-bonded to the negative electrode layer 16 with a hot plate of 200° C. An all-solid-state lithium battery was thereby prepared.

### (3) Yield of All-Solid-State Lithium Battery

The yield of the all-solid-state lithium battery was evaluated as in Examples 1 to 18.

The results are shown in Table 1.

### [Table 1]

TABLE 1

| | | | | Yield of all- |
|---|---|---|---|---|
| | End Insulator | | | solid-state |
| | Formation | | | lithium |
| Ex. | Process | Organic polymer | Filler | battery |
| 1* | None | — | — | 10% |
| 2 | Liquid | Epoxy resin | — | 70% |
| | application | | | |
| 3 | Liquid | Carboxymethyl | — | 75% |
| | application | cellulose | | |
| 4 | Liquid | Hydroxypropylmethyl | — | 80% |
| | application | cellulose | | |
| 5 | Liquid | Carboxymethyl | PTFE | 85% |
| | application | cellulose | | |
| 6 | Liquid | Hydroxypropylmethyl | PTFE | 90% |
| | application | cellulose | | |
| 7 | Liquid | Hydroxypropylmethyl | PP | 90% |
| | application | cellulose | | |
| 8 | Liquid | Hydroxypropylmethyl | Silica | 85% |
| | application | cellulose | | |
| 9 | Liquid | Poly(methyl | PP | 80% |
| | application | methacrylate) | | |
| 10 | Liquid | Poly(methyl | Alumina | 75% |
| | application | methacrylate) | | |
| 11 | Liquid | PVDF | PTFE | 75% |
| | application | | | |
| 12 | Liquid | PVDF | PP | 75% |
| | application | | | |
| 13 | Liquid | PVDF | Zirconia | 70% |
| | application | | | |
| 14 | Film pasting | Polypropylene | Zirconia | 80% |
| 15 | Film pasting | Cycloolefin polymer | — | 85% |
| 16 | Film pasting | PFA | — | 75% |
| 17 | Liquid | Hydroxypropylmethyl | PTFE | 85% |
| | application | cellulose | | |
| 18 | Liquid | Hydroxypropylmethyl | PTFE | 80% |
| | application | cellulose | | |
| 19 | Liquid | Hydroxypropylmethyl | PTFE | 90% |
| | application | cellulose | | |

*Comparative Example

What is claimed is:

1. An all-solid-state lithium battery comprising:
an oriented positive electrode plate composed of an oriented polycrystalline body made of oriented lithium transition metal oxide grains;
a solid electrolyte layer composed of a lithium-ion conductive material disposed on the oriented positive electrode plate;
a negative electrode layer disposed on the solid electrolyte layer; and
an end insulator insulating and coating ends of the oriented positive electrode plate, wherein the surface of the end insulator adjacent the solid electrolyte layer and the surface of the oriented positive electrode plate adjacent the solid electrolyte layer form one continuous surface such that no step exists between the end insulator and the surface of the oriented positive electrode plate adjacent the solid electrolyte layer; or the height of the surface of the end insulator adjacent the solid electrolyte layer is lower than that of the surface of the oriented positive electrode plate adjacent the solid electrolyte layer to form a discontinuous surface with proviso that the difference in level of a step between the end insulator and the surface of the oriented positive electrode plate adjacent the solid electrolyte layer is smaller than the thickness of the solid electrolyte layer.

2. The all-solid-state lithium battery according to claim 1, wherein the surface of the end insulator adjacent the solid electrolyte layer and the surface of the oriented positive electrode plate adjacent the solid electrolyte layer form one continuous surface such that no step exists between the end insulator and the surface of the oriented positive electrode plate adjacent the solid electrolyte layer.

3. The all-solid-state lithium battery according to claim 2, wherein the end insulator has a raised portion whose height is higher than the surface of the oriented positive electrode plate adjacent the solid electrolyte layer, and the corner of the oriented positive electrode plate adjacent the solid electrolyte layer is buried in the raised portion.

4. The all-solid-state lithium battery according to claim 1, wherein the end insulator comprises an organic polymer material capable of adhering to or coming into direct contact with the oriented positive electrode plate.

5. The all-solid-state lithium battery according to claim 4, wherein the organic polymer material is at least one selected from the group consisting of binders, heat meltable resins, and adhesives.

6. The all-solid-state lithium battery according to claim 4, wherein the organic polymer material is at least one selected from the group consisting of cellulose resins, acrylic resins, fluororesins, polyolefin resins, and epoxy resins.

7. The all-solid-state lithium battery according to claim 4, wherein the end insulator further comprises a filler.

8. The all-solid-state lithium battery according to claim 7, wherein the filler is an organic filler comprising an organic material selected from the group consisting of polytetrafluoroethylene (PTFE), tetrafluoroethylene-perfluoroalkyl vinyl ether copolymers (PFA), tetrafluoroethylene-hexafluoropropylene copolymers (FEP), polypropylene (PP), and cycloolefin polymers and/or an inorganic filler comprising an inorganic material selected from the group consisting of silica, alumina, and zirconia.

9. The all-solid-state lithium battery according to claim 4, wherein the end insulator is formed by application of a liquid or slurry comprising the organic polymer material or by pasting a film comprising the organic polymer material and then melting the film.

10. The all-solid-state lithium battery according to claim 1, wherein the oriented positive electrode plate has a thickness of 10 μm or more.

11. The all-solid-state lithium battery according to claim 1, wherein the lithium transition metal oxide grains are oriented such that the specific crystal faces of the grains are oriented in a direction crossing the plate surface of the oriented positive electrode plate.

12. The all-solid-state lithium battery according to claim 11, wherein the lithium transition metal oxide grains have a layered rock-salt structure, and the specific crystal face is a (003) plane.

13. The all-solid-state lithium battery according to claim 1, wherein the lithium transition metal oxide grains have a composition represented by LiₓM1O₂ or Liₓ(M1,M2)O₂,where 0.5<x<1.10; M1 represents at least one transition metal element selected from the group consisting of Ni, Mn, and Co; and M2 represents at least one element selected from the group consisting of Mg, Al, Si, Ca, Ti, V, Cr, Fe, Cu, Zn, Ga, Ge, Sr, Y, Zr, Nb, Mo, Ag, Sn, Sb, Te, Ba, and Bi.

14. The all-solid-state lithium battery according to claim 13, wherein the composition is represented by Liₓ(M1,M2)O₂, where M1 represents Ni and Co; and M2 represents at least one selected from the group consisting of Mg, Al, and Zr.

15. The all-solid-state lithium battery according to claim 13, wherein the composition is represented by LiₓM1O₂, where M1 represents Ni, Mn, and Co or represents Co.

16. The all-solid-state lithium battery according to claim 1, wherein the lithium-ion conductive material of the solid electrolyte layer comprises a garnet-based ceramic material, a nitride-based ceramic material, a perovskite-based ceramic material, a phosphate-based ceramic material, a sulfide-based ceramic material, or a polymer-based material.

17. The all-solid-state lithium battery according to claim 1, wherein the lithium-ion conductive material of the solid electrolyte layer comprises a Li—La—Zr—O ceramic material and/or a lithium phosphate oxynitride (LiPON) ceramic material.

18. The all-solid-state lithium battery according to claim 1, further comprising:
a positive electrode cladding made of a metal coating the outside of the oriented positive electrode plate and functioning as a positive electrode current collector;
a negative electrode cladding made of a metal coating the outside of the negative electrode layer and functioning as a negative electrode current collector; and
an end seal composed of a sealing material and sealing the oriented positive electrode plate, the solid electrolyte layer, the negative electrode layer, and the end insulator at the portions exposed without being coated with the positive electrode cladding and the negative electrode cladding.
